(19) United States
(12) Patent Application Publication
(10) Pub. No.: US 2025/0158044 A1
(43) Pub. Date: May 15, 2025

(54) SILICON-BASED ELECTROACTIVE MATERIALS FOR SODIUM-ION BATTERIES AND METHODS OF MANUFACTURING THE SAME

(71) Applicant: GM GLOBAL TECHNOLOGY OPERATIONS LLC, Detroit, MI (US)

(72) Inventors: Sayed Youssef Sayed NAGY, Troy, MI (US); Jeffrey David CAIN, Royal Oak, MI (US)

(21) Appl. No.: 18/506,173

(22) Filed: Nov. 10, 2023

(51) Int. Cl. H01M 4/38; H01M 4/02; H01M 4/04; H01M 4/62; H01M 4/66; H01M 10/054

(52) U.S. Cl. CPC H01M 4/386; H01M 4/0404; H01M 4/0471; H01M 4/049; H01M 4/622; H01M 4/661; H01M 10/054; H01M 2004/021; H01M 2004/027

(57) ABSTRACT

A negative electrode of a battery that cycles sodium ions includes a silicon-based electroactive material including two-dimensional silicon layers having a hexagonal crystal structure. The silicon-based electroactive material is configured to intercalate sodium ions between the two-dimensional silicon layers during charge of the battery and form an alloy of silicon and sodium. The silicon-based electroactive material is manufactured by extracting alkali metal ions and/or alkaline earth metal ions from a silicide precursor including two-dimensional silicon layers having a hexagonal crystal structure and spaced apart from one another by planar monolayers of alkali metal ions and/or alkaline earth metal ions. The alkali metal ions and/or the alkaline earth metal ions are extracted from the silicide precursor such that the hexagonal crystal structure of the two-dimensional silicon layers is retained in the silicon-based electroactive material.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to negative electrodes for batteries that cycle sodium ions, and more particularly to silicon-based electroactive materials for negative electrodes and methods of manufacturing the same.

Batteries that cycle sodium ions generally include a positive electrode, a negative electrode spaced apart from the positive electrode, and an ionically conductive electrolyte that provides a medium for the conduction of sodium ions between the positive and negative electrodes during discharge and charge of the batteries. Silicon is a desirable negative electrode material due to its relatively high specific capacity, as compared to graphite.

### SUMMARY

A battery that cycles sodium ions, in accordance with one or more embodiments of the present disclosure, comprises a negative electrode comprising a silicon-based electroactive material, a positive electrode spaced apart from the negative electrode, and an electrolyte that provides a medium for conduction of sodium ions between the negative electrode and the positive electrode. The silicon-based electroactive material comprises two-dimensional silicon layers having a hexagonal crystal structure and is configured to intercalate sodium ions between the two-dimensional silicon layers during charge of the battery and form an alloy of silicon and sodium. The positive electrode comprises an electroactive positive electrode material.

The negative electrode may further comprise a polymer binder and optionally an electrically conductive material. The negative electrode may have a thickness of greater than or equal to about 30 micrometers and less than or equal to about 500 micrometers.

The silicon-based electroactive material may have a specific capacity of greater than or equal to about 950 milliampere-hours per gram.

The negative electrode may be disposed on a major surface of a metal current collector.

The silicon-based electroactive material may be substantially free of crystalline silicon having a diamond, orthorhombic, or cubic crystal structure.

A method of manufacturing a negative electrode for a battery that cycles sodium ions is disclosed. The method comprises extracting alkali metal ions or alkaline earth metal ions from a silicide precursor to form a silicon-based electroactive material and depositing a continuous layer comprising the silicon-based electroactive material on a metal substrate to form the negative electrode. The silicide precursor comprises two-dimensional silicon layers having a hexagonal crystal structure and spaced apart from one another by planar monolayers of alkali metal ions or alkaline earth metal ions. The alkali metal ions or the alkaline earth metal ions are extracted from the silicide precursor such that the hexagonal crystal structure of the two-dimensional silicon layers is retained in the silicon-based electroactive material.

The alkali metal ions or the alkaline earth metal ions may be extracted from the silicide precursor by applying an acid solution to the silicide precursor.

The acid solution may comprise a hydrochloric acid (HCl) solution.

The alkali metal ions or the alkaline earth metal ions may be extracted from the silicide precursor at ambient temperature or at a temperature of less than or equal to about 0 degrees Celsius.

The silicide precursor may comprise calcium disilicide (CaSi₂). In such case, the alkali metal ions or the alkaline earth metal ions extracted from the silicide precursor may comprise calcium (Ca⁺) ions.

The silicon-based electroactive material may comprise two-dimensional silicon layers having a hexagonal crystal structure. The two-dimensional silicon layers may be terminated by hydrogen ions, hydroxyl ions, or a combination thereof.

The method may further comprise preparing a slurry comprising the silicon-based electroactive material in a solvent, depositing the slurry on the metal substrate to form a precursor layer, and removing the solvent from the precursor layer to form the negative electrode.

The slurry may further comprise a polymer binder and optionally an electrically conductive material.

The method may further comprise assembling the negative electrode into a battery comprising a positive electrode and an electrolyte that provides a medium for conduction of sodium ions between the negative electrode and the positive electrode, the positive electrode comprising sodium ions.

The method may further comprise electrically coupling the negative electrode and the positive electrode to a power source such that sodium ions are released from the positive electrode and electrochemically intercalated between the two-dimensional silicon layers of the silicon-based electroactive material of the negative electrode.

A method of manufacturing a negative electrode for a battery that cycles sodium ions is disclosed. The method comprises extracting calcium (Ca⁺) ions from a calcium silicide precursor to form a silicon-based electroactive material and depositing a continuous layer comprising the silicon-based electroactive material on a metal substrate to form the negative electrode. The calcium silicide precursor comprises two-dimensional silicon layers having a hexagonal crystal structure and spaced apart from one another by planar monolayers of calcium ions. The calcium ions are extracted from the calcium silicide precursor such that the hexagonal crystal structure of the two-dimensional silicon layers is retained in the silicon-based electroactive material.

The calcium ions may be extracted from the calcium silicide precursor by applying an acid solution to the calcium silicide precursor, or heating the calcium silicide precursor at a temperature of greater than or equal to about 1420 degrees Celsius to release calcium gas therefrom.

The method may further comprise preparing a slurry comprising the silicon-based electroactive material, a polymer binder, and optionally an electrically conductive material in a solvent, depositing the slurry on the metal substrate to form a precursor layer, and removing the solvent from the precursor layer to form the negative electrode.

The method may further comprise assembling the negative electrode into a battery comprising a positive electrode and an electrolyte that provides a medium for conduction of sodium ions between the negative electrode and the positive electrode, the positive electrode comprising sodium ions.

The method may further comprise electrically coupling the negative electrode and the positive electrode to a power source such that sodium ions are released from the positive electrode and intercalated between the two-dimensional silicon layers of the silicon-based electroactive material of the negative electrode.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle sodium ions.

FIG. 3 is a schematic cross-sectional view of a battery that cycles sodium ions, the battery comprising a positive electrode, a negative electrode, a porous separator, and an electrolyte infiltrating the positive and negative electrodes and the porous separator.

In the drawings, reference numbers may be reused to identify similar and/or identical elements.

### DETAILED DESCRIPTION

The presently disclosed silicon-based electroactive materials can be used in negative electrodes of batteries that cycle sodium ions to provide the negative electrodes with a relatively high specific capacity, as compared to that of hard carbon (e.g., graphite). The presently disclosed silicon-based electroactive materials comprise stacks of spaced-apart silicon layers. The arrangement of the silicon layers in the silicon-based electroactive materials allows sodium ions to intercalate between the silicon layers during charge of the batteries and, in turn, to alloy with the silicon in the layers and form a Si—Na alloy throughout the bulk of the silicon-based electroactive material.

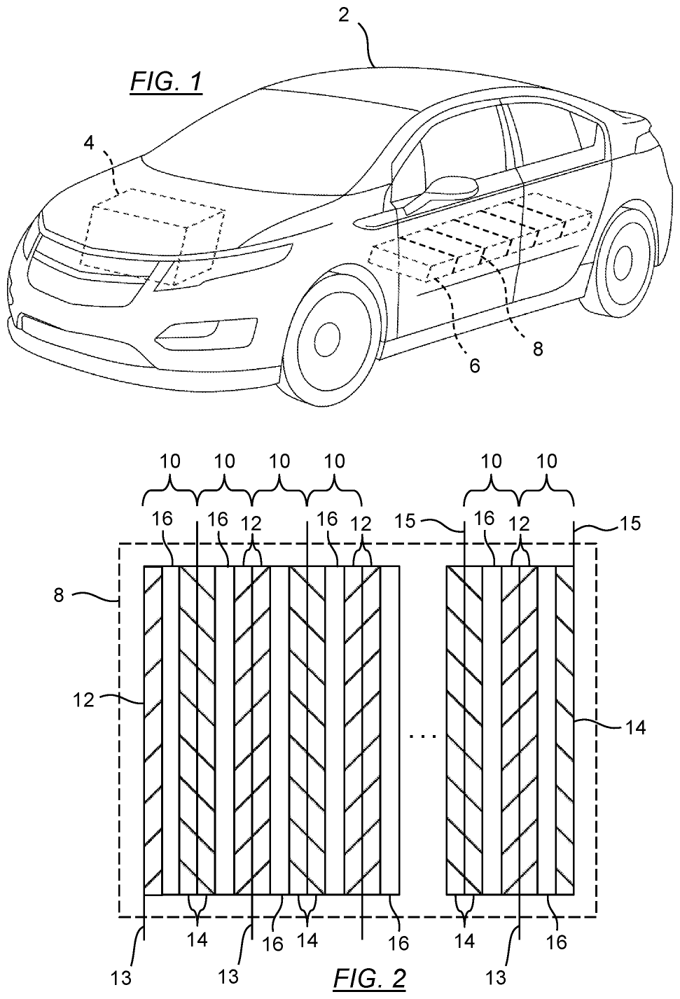

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle sodium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of sodium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

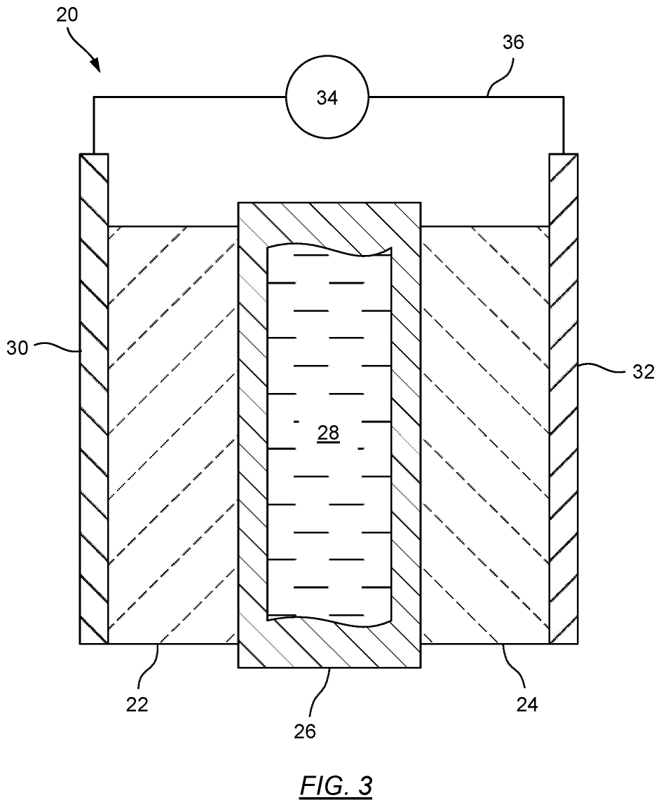

FIG. 3 depicts an electrochemical cell or battery 20 that cycles sodium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of sodium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of sodium ions and electrons at the negative electrode 22. The released sodium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of sodium, the battery 20 may be charged by connecting the negative electrode 22 and the positive electrode 24 to the power source 34, which drives nonspontaneous redox reactions within the battery 20 and the release of the sodium ions and the electrons from the positive electrode 24. The repeated discharge and charge of the battery 20 may be referred to herein as “cycling,” with a full charge event followed by a full discharge event being considered a full cycle.

The negative electrode 22 is formulated to store and release sodium ions to facilitate charge and discharge, respectively, of the battery 20. The negative electrode 22 may be in the form of a continuous layer of material disposed on a major surface of the negative electrode current collector 30. The negative electrode 22 may have a thickness of greater than or equal to about 30 micrometers (μm), optionally greater than or equal to about 50 μm, optionally greater than or equal to about 70 μm, or optionally greater than or equal to about 100 μm and less than or equal to about 500 μm.

The negative electrode 22 comprises an electrochemically active (electroactive) material that can store and release sodium ions by undergoing a reversible redox reaction with sodium during charge and discharge of the battery 20. In aspects, the negative electrode 22 may comprise a polymer binder and optionally an electrically conductive material. In such case, the electroactive material of the negative electrode 22 may be a particulate material and particles of the electroactive material may be intermingled with the polymer binder and the optional electrically conductive material. The electroactive material may constitute, by weight, greater than or equal to about 50%, optionally greater than or equal to about 60%, or optionally greater than or equal to about 70% and less than or equal to about 95%, optionally less than or equal to about 90%, or optionally less than or equal to about 80% of the negative electrode 22.

The electroactive material of the negative electrode 22 comprises a silicon-based electroactive material. The silicon-based electroactive material may constitute, by weight, greater than or equal to about 5%, optionally greater than or equal to about 10%, optionally greater than or equal to about 20%, or optionally greater than or equal to about 50% and less than or equal to about 90%, optionally less than or equal to about 80%, or optionally less than or equal to about 70% of the electroactive material of the negative electrode 22.

The silicon-based electroactive material comprises stacks of polyanionic two-dimensional silicon layers having a hexagonal crystal structure. The silicon layers may be referred to as silicene, a two-dimensional allotrope of silicon having a bucked or puckered hexagonal crystal structure (space group P63mc, 186). The silicon-based electroactive material is configured to store and release sodium ions by intercalating sodium ions between the two-dimensional silicon layers during charge of the battery 20 and to deintercalate sodium ions during discharge of the battery 20. More specifically, the two-dimensional silicon layers are spaced apart from one another a sufficient distance to allow the intercalation or insertion of sodium ions therebetween during charge of the battery 20. As such, when the battery 20 is at least partially charged, the silicon layers are spaced apart from one another by sodium (Na⁺) ions disposed therebetween. Once the sodium ions have been inserted between the two-dimensional silicon layers and are in intimate contact with the silicon ions defining the silicon layers, the sodium ions can alloy with the silicon ions, for example, by forming covalent bonds therewith, and form a silicon-sodium (Si—Na) alloy. As such, the silicon-based electroactive material may have a specific capacity of greater than or equal to about 950 milliampere-hours per gram (mAh/g). In aspects, the silicon-based electroactive material may have a specific capacity of about 954 mAh/g, the maximum theoretical sodium-storage capacity of silicon.

The silicon-based electroactive material of the negative electrode 22 may be substantially free of crystalline silicon having a diamond, orthorhombic, or cubic crystal structure. Specifically, the silicon-based electroactive material may be substantially free of the following silicon allotropes: DC-Si having a diamond crystal structure (space group Fd-3m, 227); Si₂₄ having an orthorhombic crystal structure (space group Cmcm, 63); Si₄₆ having a cubic crystal structure (space group Pm-3n, 223); Si₁₃₆ having a cubic crystal structure (space group Fd-3m, 227). In embodiments, the silicon-based electroactive material of the negative electrode 22 may be substantially free of amorphous silicon.

The silicon-based electroactive material comprises two-dimensional silicon layers having a hexagonal crystal structure. However, when other crystalline forms of silicon (e.g., DC—Si, Si₂₄, Si₄₆, or Si₁₃₆) are used as an electroactive material in a negative electrode 22 of a battery that cycles sodium ions, the high activation energy required for sodium ions to diffuse into the bulk crystalline silicon inhibits the sodium ions from alloying with the crystalline silicon and prevents the silicon from reaching its theoretical sodium-storage capacity of 954 mAh/g by formation of a Si—Na alloy. In other words, the layered arrangement of the two-dimensional silicon layers in the silicon-based electroactive material allows for the intercalation of sodium ions therebetween and, in turn, allows for the formation of a Si—Na alloy during charge of the battery 20.

The polymer binder is electrochemically inactive and may be included in the negative electrode 22 to provide the negative electrode 22 with structural integrity and/or to help the negative electrode 22 adhere to the major surface of the negative electrode current collector 30. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to about 1%, or optionally greater than or equal to about 5%, and less than or equal to about 10% of the negative electrode 22.

The optional electrically conductive material is electrochemically inactive and may be included in the negative electrode 22 to provide the negative electrode 22 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB) (e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the negative electrode 22, the optional electrically conductive material may constitute, by weight, greater than 0%, optionally greater than or equal to about 1%, or optionally greater than or equal to about 5% and less than or equal to about 10% of the negative electrode 22.

The positive electrode 24 is formulated to store and release sodium ions during discharge and charge of the battery 20. The positive electrode 24 may be in the form of a continuous porous layer disposed on the major surface of the positive electrode current collector 32. The positive electrode 24 comprises an electroactive positive electrode material, a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release sodium ions by undergoing a reversible redox reaction with sodium at a higher electrochemical potential than the electroactive material of the negative electrode 22 such that an electrochemical potential difference exists between the negative electrode 22 and the positive electrode 24. The electroactive material of the positive electrode 24 may comprise a material that can undergo sodium intercalation and deintercalation or a material that can undergo a conversion reaction with sodium. In aspects where the electroactive material of the positive electrode 24 comprises an intercalation host material that can undergo the reversible insertion or intercalation of sodium ions, the electroactive material of the positive electrode 24 may comprise a sodium transition metal oxide.

The same polymer binders and/or electrically conductive materials disclosed above with respect to the negative electrode 22 may be included in the positive electrode 24 in substantially the same amounts for substantially the same reasons.

The separator 26 physically separates and electrically isolates the negative electrode 22 and the positive electrode 24 from each other while permitting sodium ions to pass therethrough. The separator 26 has an open microporous structure and may comprise an organic and/or inorganic material. For example, the separator 26 may comprise a polymer or a combination of polymers. For example, the separator 26 may comprise one or more polyolefins, e.g., polyethylene (PE), polypropylene (PP), polyamide (PA), poly(tetrafluoroethylene) (PTFE), polyvinylidene fluoride (PVDF), and/or poly(vinyl chloride) (PVC). In one form, the separator 26 may comprise a laminate of polymers, e.g., a laminate of PE and PP.

The electrolyte 28 is ionically conductive and provides a medium for the conduction of sodium ions between the negative electrode 22 and the positive electrode 24. The electrolyte 28 comprises an organic solvent and a sodium salt in the organic solvent. The organic solvent may comprise a nonaqueous aprotic organic solvent. The sodium salt is soluble in the organic solvent and provides a passage for sodium ions through the electrolyte 28. The sodium salt may comprise an inorganic sodium salt, an organic sodium salt, or a combination thereof.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The silicon-based electroactive material of the negative electrode 22 may be manufactured from a silicide precursor. The silicide precursor may comprise an alkali metal silicide, an alkaline earth metal silicide, or a combination thereof. For example, the silicide precursor may comprise a binary compound of silicon and an alkali metal (e.g., Li, Na, K, Rb, Cs, and/or Fr), an alkaline earth metal (e.g., Be, Mg, Ca, Sr, Ba, and/or Ra), or a combination thereof. In embodiments, the alkali metal and/or the alkaline earth metal in the silicide precursor may have an ionic radius greater than or equal to that of sodium. In embodiments, the silicide precursor may comprise calcium silicide (CaSi₂). Like the silicon-based electroactive material of the negative electrode 22, the silicide precursor comprises stacks of polyanionic two-dimensional silicon layers having a hexagonal crystal structure. In the silicide precursor, the two-dimensional silicon layers are spaced apart from one another by planar monolayers of alkali metal ions, alkaline earth metal ions, or a combination thereof. In embodiments where the silicide precursor comprises calcium silicide, the two-dimensional silicon layers are spaced apart from one another by planar monolayers of calcium ions and the calcium ions are extracted from the calcium silicide precursor to form the silicon-based electroactive material of the negative electrode 22.

The alkali metal ions and/or the alkaline earth metal ions are extracted from the silicide precursor to form the silicon-based electroactive material. The alkali metal ions and/or the alkaline earth metal ions may be extracted from the silicide precursor using a chemical etching technique and/or by subjecting the silicide precursor to a thermal treatment.

In embodiments where a chemical etching technique is used to extract the alkali metal ions and/or the alkaline earth metal ions from the silicide precursor, an acid solution may be applied to the silicide precursor such that the alkali metal ions and/or the alkaline earth metal ions dissolve in the acid solution and are deintercalated from the silicide precursor, without altering the hexagonal crystal structure of the two-dimensional silicon layers (topochemical deintercalation). The acid solution may comprise an aqueous solution comprising water as a solvent or a nonaqueous solution comprising alcohol as a solvent (e.g., methanol, ethanol, etc.). The acidic solution may be a concentrated solution of an acid or a saturated solution of an acid. In embodiments, the acid solution may be applied to the silicide precursor at ambient temperature, e.g., at a temperature of about 25 degrees Celsius (° C.). Alternatively, the acid solution may be applied to the silicide precursor at a temperature of less than or equal to about 0° C., or optionally less than or equal to about −30° C. After the liquid phase acid solution is applied to the silicide precursor for a sufficient duration to extract the alkali metal ions and/or the alkaline earth metal ions therefrom and form the solid phase silicon-based electroactive material, the silicon-based electroactive material may be separated from the liquid phase by filtration and washed to remove residual reaction byproducts therefrom.

In embodiments, the acid solution applied to the silicide precursor may comprise a hydrochloric acid (HCl) solution. In some embodiments, an aqueous HCl solution may be applied to the silicide precursor at a temperature of less than or equal to about 30 degrees Celsius (° C.) to form hydrogen-terminated two-dimensional silicon layers having the formula Si₆H₆ (silicane). In other embodiments, an aqueous HCl solution may be applied to the silicide precursor at a temperature of about 0° C. to form two-dimensional silicon layers terminated by hydrogen ions and/or hydroxyl (—OH) ions and having the formula Si₆(OH)₆ and/or Si₆Hₓ(OH)₆₋ₓ (siloxene). In embodiments, a nonaqueous HCl solution may be applied to the silicide precursor to form two-dimensional silicon layers terminated by alkoxy groups having the formula Si₆H₃(OCH₃)₃ or Si₆H₃(OC₂H₅)₃ (alkoxysilane)

In embodiments where a thermal treatment is used to extract the alkali metal ions and/or the alkaline earth metal ions from the silicide precursor, the silicide precursor may be heated to a temperature greater than or equal to the boiling point of the alkali metal ions and/or the alkaline earth metal ions in the silicide precursor. Calcium has a boiling point of about 1420 degrees Celsius (° C.) at about 1 Atmosphere. As such, in embodiments where the silicide precursor comprises calcium disilicide, the silicide precursor may be heated to a temperature of greater than or equal to about 1420° C. to release calcium gas therefrom.

The silicon-based electroactive material may be assembled into a negative electrode, such as the negative electrode 22, for example, by depositing the silicon-based electroactive material on a metal substrate. In embodiments, the metal substrate may be made of substantially the same materials and have substantially the same shape as that of the negative electrode current collector 30. The silicon-based electroactive material may be deposited on the metal substrate by preparing a slurry comprising particles of the silicon-based electroactive material in a solvent. Like the negative electrode 22, the slurry may further comprise a polymer binder and optionally an electrically conductive material. The slurry may be deposited on the metal substrate to form a precursor layer, and then the solvent may be removed from the precursor layer to form the negative electrode 22.

Thereafter, the negative electrode 22 may be assembled into a battery, such as the battery 20. During charge of the battery 20, the negative electrode 22 and the positive electrode 24 are electrically coupled to the power source 34 such that sodium ions are released from the positive electrode 24 and electrochemically intercalated between the two-dimensional silicon layers of the silicon-based electroactive material of the negative electrode 22.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated. Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles sodium ions, the battery comprising:
a negative electrode comprising a silicon-based electroactive material comprising two-dimensional silicon layers having a hexagonal crystal structure, the silicon-based electroactive material being configured to intercalate sodium ions between the two-dimensional silicon layers during charge of the battery and form an alloy of silicon and sodium;
a positive electrode spaced apart from the negative electrode and comprising an electroactive positive electrode material; and
an electrolyte that provides a medium for conduction of sodium ions between the negative electrode and the positive electrode.

2. The battery of claim 1, wherein the negative electrode further comprises a polymer binder and optionally an electrically conductive material, and wherein the negative electrode has a thickness of greater than or equal to about 30 micrometers and less than or equal to about 500 micrometers.

3. The battery of claim 1, wherein the silicon-based electroactive material has a specific capacity of greater than or equal to about 950 milliampere-hours per gram.

4. The battery of claim 1, wherein the negative electrode is disposed on a major surface of a metal current collector.

5. The battery of claim 1, wherein the silicon-based electroactive material is substantially free of crystalline silicon having a diamond, orthorhombic, or cubic crystal structure.

6. A method of manufacturing a negative electrode for a battery that cycles sodium ions, the method comprising:
extracting alkali metal ions or alkaline earth metal ions from a silicide precursor to form a silicon-based electroactive material, the silicide precursor comprising two-dimensional silicon layers having a hexagonal crystal structure and being spaced apart from one another by planar monolayers of alkali metal ions or alkaline earth metal ions, wherein the alkali metal ions or the alkaline earth metal ions are extracted from the silicide precursor such that the hexagonal crystal structure of the two-dimensional silicon layers is retained in the silicon-based electroactive material; and
depositing a continuous layer comprising the silicon-based electroactive material on a metal substrate to form the negative electrode.

7. The method of claim 6, wherein the alkali metal ions or the alkaline earth metal ions are extracted from the silicide precursor by applying an acid solution to the silicide precursor.

8. The method of claim 7, wherein the acid solution comprises a hydrochloric acid (HCl) solution.

9. The method of claim 7, wherein the alkali metal ions or the alkaline earth metal ions are extracted from the silicide precursor at ambient temperature or at a temperature of less than or equal to about 0 degrees Celsius.

10. The method of claim 6, wherein the silicide precursor comprises calcium disilicide (CaSi₂), and wherein the alkali metal ions or the alkaline earth metal ions extracted from the silicide precursor comprise calcium (Ca⁺) ions.

11. The method of claim 6, wherein the silicon-based electroactive material comprises two-dimensional silicon layers having a hexagonal crystal structure, and wherein the two-dimensional silicon layers are terminated by hydrogen ions, hydroxyl ions, or a combination thereof.

12. The method of claim 6, further comprising:
preparing a slurry comprising the silicon-based electroactive material in a solvent;
depositing the slurry on the metal substrate to form a precursor layer; and
removing the solvent from the precursor layer to form the negative electrode.

13. The method of claim 12, wherein the slurry further comprises a polymer binder and optionally an electrically conductive material.

14. The method of claim 12, further comprising:
assembling the negative electrode into a battery comprising a positive electrode and an electrolyte that provides a medium for conduction of sodium ions between the negative electrode and the positive electrode, the positive electrode comprising sodium ions.

15. The method of claim 14, further comprising:
electrically coupling the negative electrode and the positive electrode to a power source such that sodium ions are released from the positive electrode and electrochemically intercalated between the two-dimensional silicon layers of the silicon-based electroactive material of the negative electrode.

16. A method of manufacturing a negative electrode for a battery that cycles sodium ions, the method comprising:
extracting calcium (Ca⁺) ions from a calcium silicide precursor to form a silicon-based electroactive material, the calcium silicide precursor comprising two-dimensional silicon layers having a hexagonal crystal structure and being spaced apart from one another by planar monolayers of calcium ions, wherein the calcium ions are extracted from the calcium silicide precursor such that the hexagonal crystal structure of the two-dimensional silicon layers is retained in the silicon-based electroactive material; and
depositing a continuous layer comprising the silicon-based electroactive material on a metal substrate to form the negative electrode.

17. The method of claim 16, wherein the calcium ions are extracted from the calcium silicide precursor by:
applying an acid solution to the calcium silicide precursor; or
heating the calcium silicide precursor at a temperature of greater than or equal to about 1420 degrees Celsius to release calcium gas therefrom.

18. The method of claim 16, further comprising:
preparing a slurry comprising the silicon-based electroactive material, a polymer binder, and optionally an electrically conductive material in a solvent;
depositing the slurry on the metal substrate to form a precursor layer; and
removing the solvent from the precursor layer to form the negative electrode.

19. The method of claim 18, further comprising:
assembling the negative electrode into a battery comprising a positive electrode and an electrolyte that provides a medium for conduction of sodium ions between the negative electrode and the positive electrode, the positive electrode comprising sodium ions.

20. The method of claim 19, further comprising:
electrically coupling the negative electrode and the positive electrode to a power source such that sodium ions are released from the positive electrode and intercalated between the two-dimensional silicon layers of the silicon-based electroactive material of the negative electrode.
